(19) United States
(12) Patent Application Publication
(10) Pub. No.: US 2021/0387123 A1
(43) Pub. Date: Dec. 16, 2021

(54) LIQUID FILTER AND MANUFACTURING METHOD FOR LIQUID FILTER

(71) Applicant: FUJIFILM Corporation, Tokyo (JP)

(72) Inventors: Kazuomi INOUE, Ashigara-kami-gun (JP); Yosuke NAKAGAWA, Ashigara-kami-gun (JP); Ryuta TAKEGAMI, Ashigara-kami-gun (JP); Kazuhide KANEMURA, Ashigara-kami-gun (JP)

(73) Assignee: FUJIFILM Corporation, Tokyo (JP)

(21) Appl. No.: 17/459,567

(22) Filed: Aug. 27, 2021

Related U.S. Application Data
(63) Continuation of application No. PCT/JP2020/002237, filed on Jan. 23, 2020.

(30) Foreign Application Priority Data
Feb. 28, 2019 (JP) 2019-036194

(51) Int. Cl. B01D 39/18; D04H 1/728; D01F 1/10

(52) U.S. Cl. CPC B01D 39/18; D04H 1/728; D01F 1/10; B01D 2239/0631; B01D 2239/0618; D10B 2401/022; B01D 2239/1216; B01D 2239/1291; B01D 2239/1208; D10B 2505/04; B01D 2239/0421

(57) ABSTRACT

There is provided a liquid filter having a small pressure loss and a manufacturing method for a liquid filter. The liquid filter is a liquid filter that is composed of a nonwoven fabric formed of fibers containing a water-insoluble polymer and a hydrophilizing agent. In the nonwoven fabric, a fiber density continuously changes in a film thickness direction, a fiber density difference is present in the film thickness direction, the fiber density of one surface of the nonwoven fabric in the film thickness direction is maximal, and the fiber density of the other surface of the nonwoven fabric in the film thickness direction is minimal.

### CROSS-REFERENCE TO RELATED APPLICATIONS

This application is a Continuation of PCT International Application No. PCT/JP2020/002237 filed on Jan. 23, 2020, which claims priority under 35 U.S.C. § 119(a) to Japanese Patent Application No. 2019-036194 filed on Feb. 28, 2019. The above application is hereby expressly incorporated by reference, in its entirety, into the present application.

### BACKGROUND OF THE INVENTION

### 1. Field of the Invention

The present invention relates to a liquid filter that is composed of a nonwoven fabric formed of fibers containing a water-insoluble polymer and a hydrophilizing agent and a manufacturing method for a liquid filter, and particularly, relates to a liquid filter having a small pressure loss and a manufacturing method for a liquid filter.

### 2. Description of the Related Art

Currently, a nonwoven fabric composed of so-called nanofibers having a fiber diameter of 1 μm or less is expected to be used for various intended purposes. Nonwoven fabrics composed of nanofibers are used, for example, in filters for filtering liquids, and are proposed in, for example, JP2012-46843A, WO2018/101156A, and JP1997-143081A (JP-H9-143081A).

JP2012-46843A discloses a filter medium containing a water-resistant cellulose sheet consisting of a nonwoven fabric composed of fine cellulose fibers having a number-average fiber diameter of 500 nm or less. The water-resistant cellulose sheet satisfies all of a weight ratio of fine cellulose fibers: 1% by mass or more and 99% by mass or less, a void ratio: 50% or more, a tensile strength equivalent to 10 g/m² weight: 6N/15 mm or more, and a wet and dry strength ratio of the tensile strength: 50% or more.

In addition, WO2018/101156A discloses a filtering medium for selective adsorption of blood components, as a substance for selectively removing blood components such as leukocytes, where the filtering medium contains cellulose acylate, has a glass transition temperature of 126° C. or higher, has an average through-hole diameter of 0.1 to 50 μm, and has a specific surface area of 1.0 to 100 m²/g. The filtering medium for selective adsorption of blood components has a nonwoven fabric form.

Further, JP1997-143081A (JP-H9-143081A) discloses a plasma separation filter with which a container having an inlet and an outlet is filled so that the average hydraulic radius of aggregates of ultrafine fibers composed of a nonwoven fabric is 0.5 μm to 3.0 μm and the ratio (L/D) between a flow path diameter (D) of a blood component and a flow path length (L) of blood is 0.15 to 6. The ultrafine fibers of JP1997-143081A (JP-H9-143081A) are polyester, polypropylene, polyamide, or polyethylene.

### SUMMARY OF THE INVENTION

A nonwoven fabric composed of nanofibers has a network structure formed by nanofibers. In a case where the nonwoven fabric is used as a filtering medium for a liquid, a filtration target such as a liquid passes through voids due to the network structure and is filtered.

However, the above-described filters of JP2012-46843A, WO2018/101156A, and JP1997-143081A (JP-H9-143081A) have a problem that the pressure loss at the time of filtering is large.

An object of the present invention is to provide a liquid filter having a small pressure loss and a manufacturing method for a liquid filter.

For achieving the above-described object, the present invention provides a liquid filter that is composed of a nonwoven fabric formed of fibers containing a water-insoluble polymer and a hydrophilizing agent, where in the nonwoven fabric, a fiber density continuously changes in a film thickness direction, a fiber density difference is present in the film thickness direction, the fiber density of one surface of the nonwoven fabric in the film thickness direction is maximal, and the fiber density of the other surface of the nonwoven fabric in the film thickness direction is minimal.

The hydrophilizing agent is preferably at least one of polyvinylpyrrolidone, polyethylene glycol, carboxymethyl cellulose, or hydroxypropyl cellulose.

The nonwoven fabric preferably has a film thickness of 200 μm or more and 2,000 μm or less.

The nonwoven fabric preferably has an average through-hole diameter of 2.0 μm or more and less than 10.0 μm.

The nonwoven fabric preferably has a void ratio of 75% or more and 98% or less.

The nonwoven fabric preferably has a critical wet surface tension of 72 mN/m or more.

The water-insoluble polymer is preferably any one of polyethylene, polypropylene, polyester, polysulfone, polyethersulfone, polycarbonate, polystyrene, a cellulose derivative, an ethylene vinyl alcohol polymer, polyvinyl chloride, polylactic acid, polyurethane, polyphenylene sulfide, polyamide, polyimide, polyvinylidene fluoride, polytetrafluoroethylene, or an acrylic resin, or a mixture thereof.

The water-insoluble polymer preferably consists of a cellulose derivative.

The content of the hydrophilizing agent with respect to the total mass of the fibers of the nonwoven fabric is preferably 1% to 50% by mass.

In addition, the present invention provides a manufacturing method for a liquid filter, in which the liquid filter of the present invention is manufactured by using an electrospinning method.

According to the present invention, it is possible to obtain a liquid filter having a small pressure loss. Further, a liquid filter having a small pressure loss can be manufactured.

### BRIEF DESCRIPTION OF THE DRAWINGS

FIG. 1 is a schematic view illustrating an example of a liquid filter according to the embodiment of the present invention.

FIG. 2 is a schematic cross-sectional view showing an example of a liquid filter according to the embodiment of the present invention.

FIG. 3 is a graph showing an example of measurement results of the liquid filter according to the embodiment of the present invention.

FIG. 4 is a graph showing the anisotropy of the liquid filter according to the embodiment of the present invention.

FIG. 5 is a schematic cross-sectional view showing an example of a conventional nonwoven fabric.

FIG. 6 is a graph showing an example of measurement results of a conventional nonwoven fabric.

FIG. 7 is a schematic view illustrating a first example of the filtering device according to the embodiment of the present invention.

FIG. 8 is a schematic view illustrating a second example of the filtering device according to the embodiment of the present invention.

FIG. 9 is a schematic view illustrating a third example of the filtering device according to the embodiment of the present invention.

FIG. 10 is a schematic view illustrating a fourth example of the filtering device according to the embodiment of the present invention.

FIG. 11 is a schematic view illustrating an example of a filtration system having a filtering device according to the embodiment of the present invention.

### DESCRIPTION OF THE PREFERRED EMBODIMENTS

Hereinafter, a liquid filter and a manufacturing method for a liquid filter, according to the embodiment of the present invention, will be described in detail based on the suitable embodiments shown in the attached drawings.

It is noted that the figures explained below are exemplary for explaining the present invention, and the present invention is not limited to the figures shown below.

In the following, “to” indicating a numerical range includes numerical values described on both sides thereof. For example, in a case where ε is a numerical value α to a numerical value β, the range of ε is a range including the numerical value α and the numerical value β and thus α≤ε≤β in a case of describing with mathematical symbols.

The “angle represented by a specific numerical value” and the “temperature represented by a specific numerical value” include an error range generally allowed in the related technical field unless otherwise specified.

(Liquid Filter)

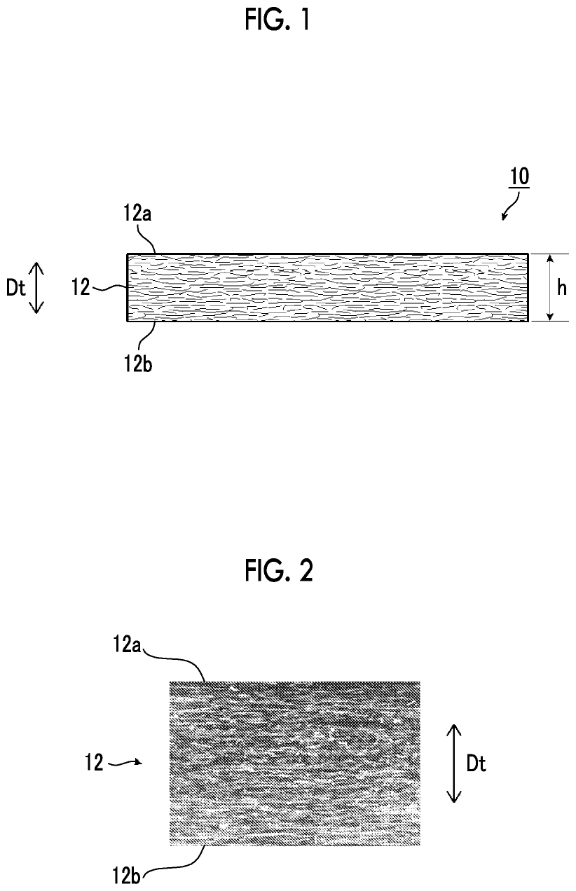

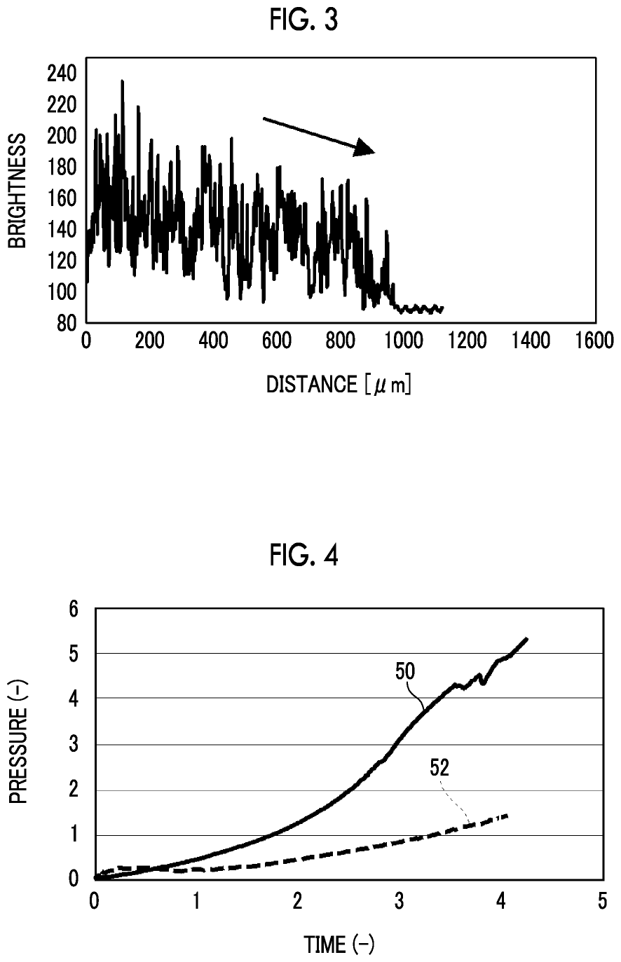

FIG. 1 is a schematic view illustrating an example of a liquid filter according to the embodiment of the present invention, and FIG. 2 is a schematic cross-sectional view showing an example of a liquid filter according to the embodiment of the present invention. FIG. 3 is a graph showing an example of measurement results of the liquid filter according to the embodiment of the present invention.

The liquid filter 10 illustrated in FIG. 1 is a liquid filter that is composed of a nonwoven fabric formed of fibers containing a water-insoluble polymer and a hydrophilizing agent, where in the nonwoven fabric, a fiber density continuously changes in a film thickness direction, a fiber density difference is present in the film thickness direction, the fiber density of one surface of the nonwoven fabric in the film thickness direction is maximal, and the fiber density of the other surface of the nonwoven fabric in the film thickness direction is minimal. As a result, in the nonwoven fabric, a fiber density difference is present between one surface and the other surface. The continuous change in fiber density will be described in detail later.

Due to the above configuration, the liquid filter 10 has a small pressure loss. As a result, the force required for filtration can be reduced in the liquid filter 10.

The filtration target of the liquid filter 10 is not particularly limited as long as it contains a liquid, and is, for example, a liquid containing particles. In addition to this, a liquid containing microorganisms is also included in the filtration target. The microorganisms include bacteria, protozoa, yeasts, viruses, and algae. The liquid filter 10 can remove, for example, fine particles, microorganisms, and the like from drinking water and the like.

Regarding the liquid filter 10, the filtration target, the size that can be filtered, and the like are collectively referred to as separation characteristics.

The filtration with the liquid filter 10 includes filtering elimination as well as filtration. In the liquid filter 10, instead of the filtration target, a filtering elimination target can also be supplied and subjected to filtering elimination. In the liquid filter 10, the pressure loss is small even in the case of filtering elimination.

In the liquid filter 10, specifically, the fiber density is different in the film thickness direction Dt as shown in FIG. 2. In the nonwoven fabric 12 shown in FIG. 2, the fiber density on a back surface 12b side is low, the fiber density on a front surface 12a side is high, and the fiber density changes continuously in the film thickness direction Dt.

As described above, the nonwoven fabric constituting the liquid filter 10 is composed of fibers containing a water-insoluble polymer and a hydrophilizing agent and has through-holes. The nonwoven fabric 12 preferably has a film thickness h (see FIG. 1) of 200 μm or more and 2,000 μm or less.

Further, the nonwoven fabric 12 preferably has an average through-hole diameter of 2.0 μm or more and less than 10.0 μm, and a void ratio of 75% or more and 98% or less. Further, the critical wet surface tension is preferably 72 mN/m or more.

Hereinafter, the liquid filter will be described more specifically.

<Nonwoven Fabric>

As described above, the liquid filter is composed of a nonwoven fabric formed of fibers containing a water-insoluble polymer and a hydrophilizing agent.

The nonwoven fabric preferably consists of fibers having an average fiber diameter of 1 nm or more and 5 μm or less and having an average fiber length of 1 mm or more and 1 m or less, more preferably consists of nanofibers having an average fiber diameter of 100 nm or more and less than 1,000 nm and having an average fiber length of 1.5 mm or more and 1 m or less, and still more preferably consists of nanofibers having an average fiber diameter of 100 nm or more and 800 nm or less and having an average fiber length of 2.0 mm or more and 1 m or less.

The average fiber diameter and the average fiber length can be adjusted, for example, by adjusting the concentration of a solution at the time of manufacturing the nonwoven fabric.

Here, the average fiber diameter refers to a value measured as follows.

A transmission electron microscope image or a scanning electron microscope image of the surface of a nonwoven fabric consisting of fibers is obtained.

The electron microscope image is obtained at a magnification selected from 1,000 to 5,000 times depending on the size of the fibers constituting the nonwoven fabric. However, the sample, the observation conditions, and magnification are adjusted so that the following conditions are satisfied.

(1) A straight line X is drawn at any position in the electron microscope image so that 20 or more fibers intersect the straight line X.

(2) In the same electron microscope image, a straight line Y that perpendicularly intersects the straight line X is drawn so that 20 or more fibers intersect the straight line Y.

Regarding each of the fibers crossing the straight line X and the fibers crossing the straight line Y in the electron microscope image as described above, the width (the short diameter of the fiber) of at least 20 fibers (that is, at least 40 fibers in total) is read. In this manner, at least 3 sets or more of the above-described electron microscope images are observed, and fiber diameters of at least 40 fibers×3 sets (that is, at least 120 fibers) are read.

The average fiber diameter is obtained by averaging the fiber diameters read in this manner.

In addition, the average fiber length refers to a value measured as follows.

That is, the fiber length of the fiber can be obtained by analyzing the electron microscope image that is used in measuring the above-described average fiber diameter.

Specifically, regarding each of the fibers crossing the straight line X and the fibers crossing the straight line Y in the electron microscope image as described above, the fiber length of at least 20 fibers (that is, at least 40 fibers in total) is read.

In this manner, at least 3 sets or more of the above-described electron microscope images are observed, and fiber lengths of at least 40 fibers×3 sets (that is, at least 120 fibers) are read.

The average fiber length is obtained by averaging the fiber lengths read in this manner.

<Fiber Density Difference>

The Configuration of the nonwoven fabric constituting the liquid filter is as described above. In the nonwoven fabric, a fiber density continuously changes in a film thickness direction, a fiber density difference is present in the film thickness direction, the fiber density of one surface of the nonwoven fabric in the film thickness direction is maximal, the fiber density of the other surface of the nonwoven fabric in the film thickness direction is minimal, and a fiber density difference is present between the one surface and the other surface. The fiber density difference is the ratio of the minimum fiber density to the maximum fiber density, as will be described later.

Regarding the fiber density difference in the film thickness direction of the nonwoven fabric constituting the liquid filter, in a case where the fiber density difference is small, cake filtration occurs, and the processing pressure increases. On the other hand, in a case where the fiber density difference is large, stepwise filtration is possible, and the processing pressure can be decreased.

The processing pressure corresponds to the pressure loss during the filtration. A low processing pressure means that the pressure loss during the filtration is small, and the resistance of the liquid filter during the filtration is small. In a case where the pressure loss is small, the pressure required for filtration can be decreased.

The pressure loss is the difference between a static pressure on the front surface side and a static pressure on the back surface side in the film thickness direction across the liquid filter. Accordingly, the pressure loss can be determined by measuring the static pressure on the front surface side and the static pressure on the back surface side and obtaining the difference between the two static pressures. The pressure loss can be measured using a differential pressure gauge.

Here, the fiber density correlates with the brightness of the X-ray computed tomography (CT) image, and the fiber density can be specified by the brightness. For example, the result shown in FIG. 3 can be obtained. The higher the brightness of the X-ray CT image, the higher the fiber density. In FIG. 3, as the distance value increases, the brightness tends to decrease, and thus the fiber density decreases.

The fiber density difference in the film thickness direction is obtained by carrying out a cross-sectional X-ray CT image analysis in the film thickness direction. First, a cross-sectional X-ray CT image is acquired, the entire film thickness in the cross-sectional X-ray CT image is equally divided into 10 sections in the film thickness direction, and the brightness in each of the sections is integrated. The integrated brightnesses are denoted by L1, L2, L3, L4, L5, L6, L7, L8, L9, and L10 in order from the lowest brightness. In the present invention, the brightness L1 is a brightness of one surface of the front surface and the back surface of the nonwoven fabric, and the brightness L10 is a brightness of the other surface of the front surface and the back surface of the nonwoven fabric. Among the front surface 12a and the back surface 12b of the nonwoven fabric 12, the fiber density of any one surface is maximal, and the fiber density of the remaining surface is minimal.

“There is a fiber density difference in the film thickness direction” refers to that the ratio of the minimum value of brightness to the maximum value of brightness is L1/L10<0.95.

As shown in FIG. 4, in a case where a fiber density difference is present in the film thickness direction, the pressure required for filtration is different in the film thickness direction between a case where filtration is carried out from a surface with the higher fiber density (see a pressure curve 50) and a case where filtration is carried out from a surface with the lower fiber density (see a pressure curve 52). That is, the liquid filter 10 has anisotropy in the film thickness direction. In a case where a filtration target is allowed to pass from a low fiber density side to a high fiber density side in the film thickness direction, it is possible to reduce the pressure loss. That is, the pressure required for filtration can be reduced.

In addition, FIG. 4 shows the results of carrying out filtration using the same liquid and changing only the direction of the liquid filter 10. Both the pressure and the time in FIG. 4 are both dimensionless.

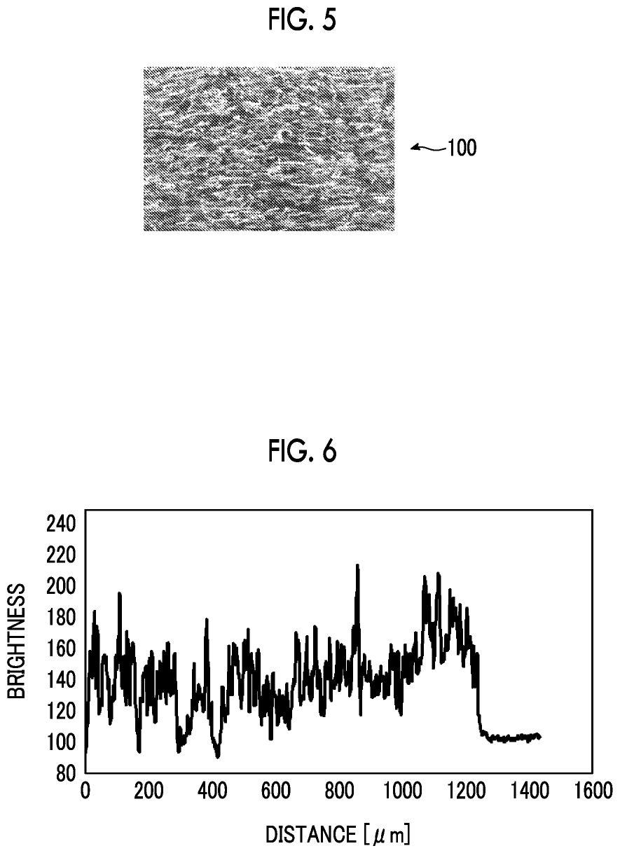

Here, FIG. 5 is a schematic cross-sectional view showing an example of a conventional nonwoven fabric, and FIG. 6 is a graph showing an example of measurement results of a conventional nonwoven fabric.

As shown in FIG. 5, in a conventional nonwoven fabric 100, the fibers are not unevenly distributed. Further, the fiber density is not biased as shown in the graph of the brightness of the X-ray CT image in FIG. 6. In the conventional nonwoven fabric, there is no fiber density difference in the film thickness direction and the fiber density is not different in the specific direction, and thus the conventional nonwoven fabric is isotropic. As a result, even in a case where the supply direction of a filtration target is changed, there is no big difference in the pressure required for filtration.

“The fiber density continuously changes in the film thickness direction” described above refers to that the above-described brightnesses L1 to L10 satisfy 0.9<Ln/Ln+1<1.05. Here, n is 1 to 9.

In a case where the fiber density continuously changes in the film thickness direction, it is referred to that the fiber density has a gradient in the film thickness direction.

In a case where the above-described brightnesses L1 to L10 does not satisfy 0.9<Ln/Ln+1<1.05, the fiber density does not continuously change in the film thickness direction. That is, the fiber density has no gradient in the film thickness direction. “The fiber density does not continuously change in the film thickness direction” described above is also referred to as discontinuous.

In a case where the fiber density continuously changes in the film thickness direction, it is preferable that there is no sudden change in the fiber density. However, it is permissible that the fiber density reversely varies in a part of the 10 sections which are obtained by being equally divided into 10 sections in the film thickness direction described above. That is, in a case where L1/L10<0.95 is satisfied, the fiber density is not limited to being that the fiber density represented by the brightness gradually increases or gradually decreases in one direction in the above-described 10 sections which are obtained by being equally divided into 10 sections in the film thickness direction, and sections having the same fiber density may be adjacent to each other.

The above-described L1/L10 is more preferably 0.3≤L1/L10<0.95, still more preferably 0.4≤L1/L10<0.9, and most preferably 0.5≤L1/L10<0.9.

In a case where the fiber density continuously changes in the film thickness direction, the pressure loss can be reduced. For example, it is also possible to reduce the pressure loss in a case where the processing amount is 80% to 100% by volume of the total amount of the liquid to be filtered.

On the other hand, in a case where the fiber density does not continuously change in the film thickness direction, the pressure loss is large.

<Average Through-Hole Diameter>

The average through-hole diameter is preferably 2.0 μm or more and less than 10.0 μm, more preferably 2.0 μm or more and less than 8.0 μm, still more preferably 3.0 μm or more and less than 7.0 μm, and most preferably 3.0 μm or more and less than 5.0 μm.

In a case where the average through-hole diameter is small as compared with the size of the filtration target, the pressure loss increases. That is, the processing pressure increases. In a case where the average through-hole diameter is large as compared with the size of the filtration target, the pressure loss decreases. That is, the processing pressure decreases.

The average through-hole diameter can be measured with a palm porometer by using a bubble point method (Japanese Industrial Standards (JIS) K3832, ASTM F316-86)/Half-dry Method (ASTM E1294-89). Hereinafter, the average through-hole diameter will be described in detail.

Regarding the “average through-hole diameter”, in a pore diameter distribution measurement test using a palm porometer (CFE-1200AEX, manufactured by Seika Corporation), the air pressure is increased by 2 cc/min with respect to a sample completely wetted with GALWICK (Porous Materials, Inc.) in the same manner as in the method described in paragraph <0093> of JP2012-046843A, and evaluation is carried out. Specifically, with respect to a film-shaped sample completely wetted with GALWICK (1,1,2,3,3,3-hexafluoropropene; manufactured by Porous Materials, Inc.), a predetermined amount of air is sent at 2 cc/min to one side of the film, and while measuring the pressure, the flow rate of the air permeating to the opposite side of the film is measured. From this method, first, data on the pressure and the permeating air flow rate (hereinafter, also referred to as “wet curve”) is obtained for the film-shaped sample which has been wetted with GALWICK. Next, the same data (hereinafter, also referred to as “dry curve”) is measured for a non-wet, dry film-shaped sample, and a pressure at an intersection of a curve (a half dry curve) corresponding to half of the flow rate of the dry curve and the wet curve) are obtained. Thereafter, the surface tension (γ) of GALWICK, the contact angle (θ) with the filtering medium, and the air pressure (P) are introduced into the following Expression (I) to calculate the average through-hole diameter.

Average through-hole diameter=4γ cos θ/P (I)

Examples of the method for adjusting the average through-hole diameter include the methods described below.

((Control of Fiber Diameter))

In the method for controlling the fiber diameter, which is one of the methods for adjusting the average through-hole diameter, the fiber diameter can be controlled by changing the solvent, the concentration of the material, the voltage, and the like, which are used at the time of spinning by electrospinning. Since there is a proportional relationship between the fiber diameter and the average through-hole diameter, the average through-hole diameter can be adjusted by controlling the fiber diameter.

((Heat Fusion Welding))

In the method using heat fusion welding, which is one of the methods for adjusting the average through-hole diameter, the fibers can be fusion-welded to each other and the average through-hole diameter can be reduced. In heat fusion welding, unlike the control of the fiber diameter, the average through-hole diameter can only be reduced.

((Calender Treatment))

In the method using calender treatment, which is one of the methods for adjusting the average through-hole diameter, the average through-hole diameter can be reduced by pressurizing and crushing fibers with a roller or the like to firmly sticking the fibers. In calender treatment, unlike the control of the fiber diameter, the average through-hole diameter can only be reduced.

<Void Ratio>

The void ratio is preferably 75% or more and 98% or less, more preferably 85% or more and 98% or less, and still more preferably 90% or more and 98% or less.

The higher the void ratio is, the more hardly the cake filtration occurs, and the more hardly the processing pressure increases. That is, the pressure loss hardly increases. As a result, the supply speed of the filtration target can be increased at the time of filtration. On the other hand, in a case where the void ratio is low, it is easy to shift to the cake filtration, and the processing pressure tends to increase, that is, the pressure loss tends to be large. It is difficult to manufacture a nonwoven fabric having a void ratio of more than 98%.

The void ratio is calculated as follows.

First, in a case where the void ratio is denoted by Pr (%), the film thickness of a nonwoven fabric of a square of 10 cm×10 cm is denoted by Hd (μm), and the mass of a nonwoven fabric of a square of 10 cm×10 cm is denoted by Wd (g), the void ratio is calculated using Pr=(Hd−Wd×67.14)×100/Hd.

<Film Thickness>

In the liquid filter, the nonwoven fabric preferably has a film thickness h (see FIG. 1) of 200 μm or more and 2,000 μm or less and more preferably 200 μm or more and 1,000 μm or less.

The film thickness h of the nonwoven fabric (see FIG. 1) is the film thickness of the liquid filter.

In a case where the film thickness is not equal to or more than a predetermined thickness, there is no fiber density difference. In a case where the film thickness is too thin, the components desired to be removed cannot be completely removed, which leads to a decrease in filter performance.

On the other hand, in a case where the film thickness is too thick, high pressure is required to cause all the separation targets such as the filtration target to permeate, and thus the pressure loss tends to be large.

For the film thickness, a cross-sectional observation of the nonwoven fabric is carried out using a scanning electron microscope to obtain a cross-sectional image. Using the cross-sectional image, 10 points as the film thickness of the nonwoven fabric were measured, and the average value thereof was taken as the film thickness.

<Critical Wet Surface Tension>

Critical wet surface tension (CWST) is a parameter representing wettability.

The critical wet surface tension (CWST) is 72 millinewtons per meter (mN/m) or more, and the critical wet surface tension (CWST) is preferably 85 mN/m or more.

In a case where the critical wet surface tension (CWST) is high, the filtration target easily spreads wettably on the nonwoven fabric, and thus the effective area becomes large and the pressure loss tends to be small.

In a case where the critical wet surface tension (CWST) is low, the effective area tends to be small and the pressure loss tends to be large. Critical wet surface tension (CWST) can be controlled with the amount of the hydrophilizing agent or the alkali treatment.

The definition of critical wet surface tension (CWST) is as follows.

The critical wet surface tension can be determined by observing the absorption or non-absorption of each liquid on the surface while changing the surface tension of the liquid, which is applied onto the measurement target surface, by 2 mN/m to 4 mN/m.

The unit of CWST is mN/m, which is defined as the average value of the surface tension of the absorbed liquid and the surface tension of the adjacent unabsorbed liquid. As an example, the surface tension of the absorbed liquid is 27.5 mN/m, and the surface tension of the unabsorbed liquid is 52 mN/m. In a case where a surface tension interval is an odd number, for example, 3, then it can be determined whether the nonwoven fabric is closer to the lower value or closer to the higher value, and based on this determination, 27 or 28 is assigned to the nonwoven fabric.

In measuring CWST, a series of standard test liquids of which the surface tension sequentially changes by about 2 to about 4 mN/m are prepared. Each liquid of at least two standard liquids of which the surface tensions are sequential, where each liquid has a diameter of 3 to 5 mm, is placed on a nonwoven fabric, left for 10 minutes, and observed after 10 to 11 minutes. The case of being “wet” is defined in a case where at least 9 out of 10 liquid droplet are absorbed by the nonwoven fabric, that is wetted, within 10 minutes.

Being non-wet is defined by non-wetting, that is, non-absorption of two or more liquid droplets within 10 minutes. Using continuous high or low surface tension liquids, the test is continued until one of the pair with the narrowest surface tension is determined as wet and the other is determined as non-wet.

CWST is within the range of these conditions, and for convenience, the average of the two surface tensions can be used as one number to specify the CWST. In a case where the two test liquids differ by 3 mN/m, it is determined which test liquids the test piece is closer to and an integer is assigned as described above. Solutions with different surface tensions can be made by various methods. Specific examples are shown below.

Sodium hydroxide aqueous solutions: 94 to 115 (mN/m)

Calcium chloride aqueous solutions: 90 to 94 (mN/m)

Sodium nitrate aqueous solutions: 75 to 87 (mN/m)

Pure water: 72.4 (mN/m)

Acetic acid aqueous solutions 38 to 69 (mN/m)

Ethanol aqueous solutions: 22 to 35 (mN/m)

<Water-Insoluble Polymer>

The water-insoluble polymer is a polymer having a solubility of less than 0.1% by mass in pure water.

As a specific example, the water-insoluble polymer is preferably any one of polyethylene, polypropylene, polyester, polysulfone, polyethersulfone, polycarbonate, polystyrene, a cellulose derivative, an ethylene vinyl alcohol polymer, polyvinyl chloride, polylactic acid, polyurethane, polyphenylene sulfide, polyamide, polyimide, polyvinylidene fluoride, polytetrafluoroethylene, or an acrylic resin, or a mixture thereof. Since the cellulose derivative has smaller adsorption of biological substances than other materials, the component matching rate is good. Accordingly, the water-insoluble polymer is more preferably a cellulose derivative.

The cellulose derivative refers to a modified cellulose obtained by chemically modifying a part of hydroxy groups contained in cellulose which is a natural polymer. The chemical modification of the hydroxy group is not particularly limited, and examples thereof include the alkyl etherification of the hydroxy group, the hydroxyalkyl etherification, and the esterification. The cellulose derivative has at least one hydroxy group in one molecule. Only one kind of cellulose derivative may be used, or two or more kinds thereof may be used in combination.

Examples of the cellulose derivative include methyl cellulose, ethyl cellulose, propyl cellulose, butyl cellulose, hydroxyethyl cellulose, hydroxypropyl cellulose, hydroxypropyl methyl cellulose, hydroxybutyl methyl cellulose, cellulose acetate (acetyl cellulose, diacetyl cellulose, triacetyl cellulose, and the like), cellulose acetate propionate, cellulose acetate butyrate, and nitrocellulose.

Further, in the fibers constituting the nonwoven fabric, the content of the water-insoluble polymer is preferably 50% to 99% by mass, more preferably 70% to 93% by mass, and still more preferably 85% to 93% by mass, with respect to the total mass of the fibers of the nonwoven fabric.

In a case where the content of the water-insoluble polymer is less than 50% by mass, the strength of the fibers forming the nonwoven fabric is decreased, the shape is easily changed by filtration, whereby the processing pressure is increased. On the other hand, in a case where the content of the water-insoluble polymer is 99% by mass or more, the amount of the hydrophilizing agent is reduced, and the hydrophilization effect of the fibers forming the nonwoven fabric is reduced. From this reason, the content of the water-insoluble polymer is preferably 50% to 99% by mass.

<Hydrophilizing Agent>

The hydrophilizing agent is a material having a solubility of 1% by mass or more in pure water.

As a specific example, the hydrophilizing agent is preferably at least one of polyvinylpyrrolidone, polyethylene glycol, carboxymethyl cellulose, or hydroxypropyl cellulose, and the hydrophilizing agent is most preferably polyvinylpyrrolidone.

Since polyvinylpyrrolidone is highly hydrophilic as compared with hydroxypropyl cellulose, the critical wet surface tension (CWST) of the nonwoven fabric is high. Carboxymethyl cellulose material itself has hydrophilicity comparable to that of polyvinylpyrrolidone. However, carboxymethyl cellulose has relatively weak strength and the processing pressure tends to increase since it is inferior in compatibility with a water-insoluble polymer as compared with polyvinylpyrrolidone, and the component matching after filtration is inferior since the carboxymethyl cellulose material has large adsorption of biological molecules.

Further, in the fibers constituting the nonwoven fabric, the content of the hydrophilizing agent is preferably 1% to 50% by mass, more preferably 5% to 30% by mass, and still more preferably 7% to 15% by mass, with respect to the total mass of the fibers of the nonwoven fabric.

In a case where the content of the hydrophilizing agent is more than 50% by mass, the strength of the fibers forming the nonwoven fabric is decreased, the shape is easily changed by filtration, whereby the processing pressure is increased. On the other hand, in a case where the content of the hydrophilizing agent is less than 1% by mass, the amount of the hydrophilizing agent is small, and the hydrophilization effect of the fibers forming the nonwoven fabric is reduced. From this reason, the content of the hydrophilizing agent is preferably 1% to 50% by mass.

(Manufacturing Method for Liquid Filter)

As described above, the liquid filter is composed of a nonwoven fabric that is formed of fibers containing a water-insoluble polymer and a hydrophilizing agent, where the fiber density continuously changes in the film thickness direction, and has a fiber density difference in the film thickness direction.

The liquid filter is manufactured using an electric field spinning method, also called an electrospinning method. In this manner, a liquid filter having a small pressure loss can be manufactured.

A manufacturing method using an electrospinning method will be described. First, for example, a solution in which the above-described water-insoluble polymer and the hydrophilizing agent are dissolved in a solvent is discharged from the distal end of a nozzle at a predetermined temperature within a range of 5° C. or higher and 40° C. or lower, a voltage is applied between the solution and a collector to eject fibers from the solution onto a support provided on the collector, and then the nanofibers are collected, whereby a nanofiber layer, that is, a nonwoven fabric can be obtained. In this case, the voltage applied between the solution and the collector is adjusted to change the fiber density at the time of ejecting fibers, and thus it is possible to obtain a nonwoven fabric in which a fiber density continuously changes in a film thickness direction, a fiber density difference is present in the film thickness direction, the fiber density of one surface of the nonwoven fabric in the film thickness direction is maximal, and the fiber density of the other surface of the nonwoven fabric in the film thickness direction is minimal. In addition, it is also possible to obtain, by changing the fiber density by adjusting the concentration of the solution, a nonwoven fabric in which a fiber density continuously changes in a film thickness direction, a fiber density difference is present in the film thickness direction, the fiber density of one surface of the nonwoven fabric in the film thickness direction is maximal, and the fiber density of the other surface of the nonwoven fabric in the film thickness direction is minimal.

As the manufacturing device, for example, the nanofiber manufacturing device disclosed in JP6132820B can be used. The solution contains a water-insoluble polymer and a hydrophilizing agent dissolved in a solution, and the water-insoluble polymer and the hydrophilizing agent are not separately injected from a nozzle to be spun.

(Filtering Device)

It is possible to constitute a filtering device using the liquid filter described above. The filtering device has a small pressure loss like the liquid filter.

The filtering device has a liquid filter, and the liquid filter is arranged so that a filtration target passes through the liquid filter from a low fiber density side to a high fiber density side in the film thickness direction. In a case where the liquid filter is arranged so that a filtration target is allowed to pass from a low fiber density side to a high fiber density side in the film thickness direction, it is possible to reduce the pressure loss. As a result, the pressure required for filtration can be reduced.

The filtering device may have a configuration, for example, having, in addition to the liquid filter, a porous body in which an average through-hole diameter is 0.2 μm or more and 1.5 μm or less and a void ratio is 60% or more and 95% or less. In this case, the liquid filter and the porous body are arranged so that a filtration target passes through the liquid filter and the porous body in this order.

Hereinafter, the filtering device will be specifically described.

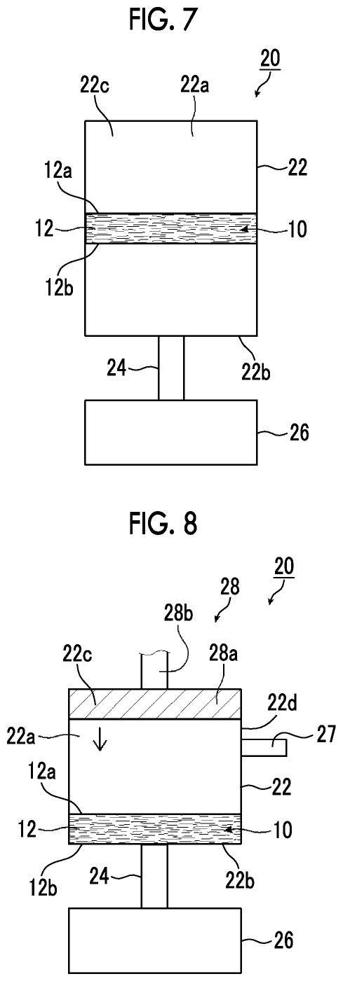

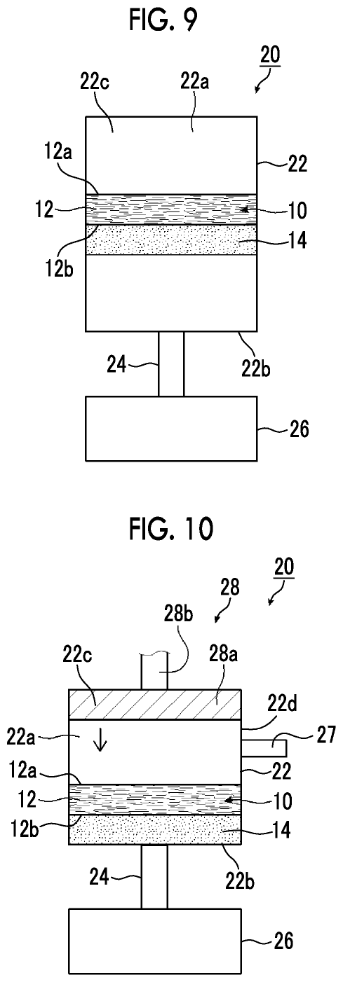

FIG. 7 is a schematic view illustrating a first example of the filtering device according to the embodiment of the present invention, and FIG. 8 is a schematic view illustrating a second example of the filtering device according to the embodiment of the present invention. FIG. 9 is a schematic view illustrating a third example of the filtering device according to the embodiment of the present invention, and FIG. 10 is a schematic view illustrating a fourth example of the filtering device according to the embodiment of the present invention.

In the filtering devices of FIG. 7 to FIG. 10, the same components as those of the liquid filter 10 illustrated in FIG. 1 are designated by the same references, and detailed descriptions thereof will be omitted.

In a filtering device 20 illustrated in FIG. 7, for example, a disk-shaped liquid filter 10 is provided in an inside 22a of a cylindrical case 22. In a bottom part 22b of the case 22, a connecting pipe 24 is provided at the center of the bottom part 22b. The connecting pipe 24 is connected to a collection unit 26.

In the case 22, an end on a side opposite to bottom part 22b is opened. The portion that is opened is called an opening portion 22c. A filtration target is supplied from the opening portion 22c, filtered by the liquid filter, passed through the connecting pipe 24 from the bottom part 22b of the case 22, and the filtered filtration target is stored in a collection unit 26.

In the filtering device 20, instead of the filtration target, a filtering elimination target can also be supplied and subjected to filtering elimination. In this case, a filtering elimination target is supplied from the opening portion 22c, subjected to filtering elimination by the liquid filter, passed through the connecting pipe 24 from the bottom part 22b of the case 22, and the filtering elimination target undergone filtering elimination is stored in a collection unit 26.

Further, as illustrated in FIG. 8, the filtering device 20 may have a configuration having a pressurizing part 28. The pressurizing part 28 is provided in the opening portion 22c of the case 22. The pressurizing part 28 has a gasket 28a provided in the opening portion 22c and arranged without a gap between the gasket and the inside 22a of the case 22 and a plunger 28b which moves the gasket 28a in the direction from the opening portion 22c toward the bottom part 22b or in the opposite direction. In a case where the plunger 28b is moved toward the bottom part 22b, the filtration target in the inside 22a of the case 22 can be allowed to permeate through the liquid filter 10 to be filtered.

In a case where the pressurizing part 28 is provided, a supply pipe 27 communicating with the inside 22a of the case 22 may be provided on the outer surface 22d of the case 22. The supply pipe 27 is provided on the opening portion 22c side of the liquid filter 10.

Further, in the filtering device 20 having the pressurizing part 28, instead of the filtration target, a filtering elimination target can also be supplied and subjected to filtering elimination.

Further, as illustrated in FIG. 9, the filtering device 20 may have a configuration having an object having a filter function in addition to the liquid filter 10. The object having a filter function preferably an object having separation characteristics different from those of the liquid filter 10. In this case, even those that cannot be completely filtered by the liquid filter 10 can be filtered, and thus the separation accuracy can be improved.

The filtering device 20 illustrated in FIG. 9 is different from the filtering device 20 illustrated in FIG. 7 in that a porous body 14 is provided on the bottom part 22b side of the case 22 of the liquid filter 10, and the configuration other than the above is the same as that of the filtering device 20 illustrated in FIG. 7.

For example, the porous body 14 is provided to be in contact with the back surface 12b of the nonwoven fabric 12 constituting the liquid filter 10. The filtration target is supplied from the liquid filter 10 side. In the filtering device 20 illustrated in FIG. 9, the liquid filter 10 is also referred to as a primary filter, and the porous body 14 is also referred to as a secondary filter.

For, example, the porous body 14 has an average through-hole diameter of 0.2 μm or more and 1.5 μm or less, has a void ratio of 60% or more and 95% or less, and is different from the liquid filter 10 in the separation characteristics.

The porous body 14 can be composed of, for example, the same material as that of the nonwoven fabric 12 and can be composed of fibers containing the water-insoluble polymer and the hydrophilizing agent that constitute the nonwoven fabric 12. Since the definition of the average through-hole diameter and the void ratio of the porous body 14 is the same as that of the liquid filter 10, detailed descriptions thereof will be omitted.

In the filtering device 20 illustrated in FIG. 9, the liquid filter 10 and the porous body 14 are provided, and thus even those that cannot be completely filtered by the liquid filter 10 can be filtered, whereby the separation accuracy can be improved.

The filtering device 20 illustrated in FIG. 9 can also have a configuration in which the pressurizing part 28 is provided in the same manner as in the filtering device 20 illustrated in FIG. 8. Since the pressurizing part 28 has the same configuration as the filtering device 20 illustrated in FIG. 8, detailed descriptions thereof will be omitted. Further, the supply pipe 27 may be provided in the same manner as in the filtering device 20 illustrated in FIG. 8.

In addition, the porous body 14 is not limited to the above-described configurations, and those matching with the separation characteristics of the liquid filter 10, the filtration target, or the filtering elimination target can be appropriately used. However, it is preferable that the separation characteristics are different from those of the liquid filter 10 as described above.

Further, in the above, although one porous body 14 is provided in addition to the liquid filter 10, the configuration is not limited to this, and a plurality of objects having a filter function, like the porous body 14, may be provided.

The liquid filter 10 and the porous body 14 are not limited to be provided to be in contact with each other, and the liquid filter 10 and the porous body 14 may be arranged to be spaced apart from each other in the film thickness direction of the liquid filter 10.

Any one of the above-described filtering devices 20 has a configuration in which one liquid filter 10 is provided; however, the configuration is not limited to this, and a plurality of liquid filters 10 may be provided. For example, a plurality of liquid filters 10 may be arranged to be spaced apart from each other in the film thickness direction.

Further, in any one of the above-described filtering devices 20, the position of the liquid filter 10 is not particularly limited as long as it is in the inside 22a of the case 22, and may be spaced apart from the bottom part 22b of the case 22, or may be in contact with the bottom part 22b of the case 22. The liquid filter 10 may be installed in the case 22 in a state where the nonwoven fabric is provided in a flat film shape in a housing (not shown) with respect to the case 22.

Further, in any one of the above-described filtering devices 20, the collection unit 26 may not be provided, and the bottom part 22b may be closed without the connecting pipe 24 and the collection unit 26 being provided. In a case where the bottom part 22b is closed, the filtered material may be allowed to be stored in the bottom part 22b.

Further, in a case where the bottom part 22b is closed, an opening that communicates with the inside 22a of the case 22 may be provided at the bottom part 22b so that the filtered material is taken out to the outside.

(Filtration System)

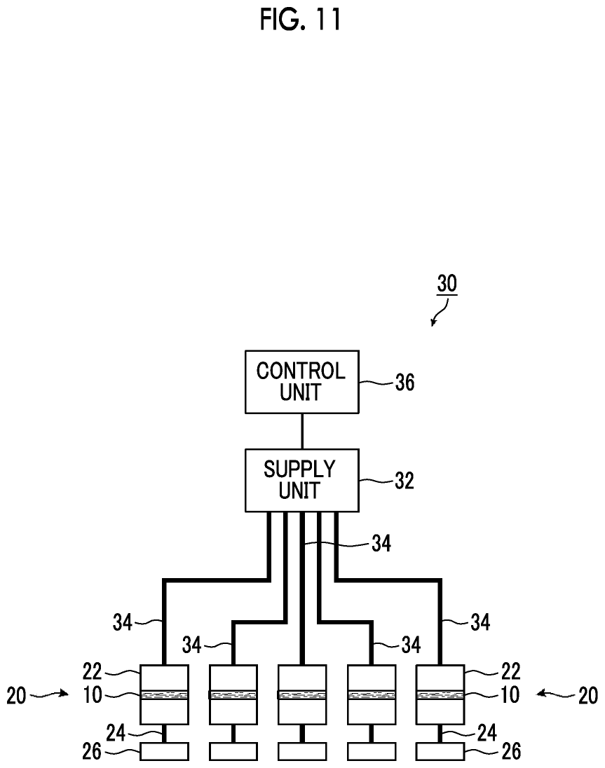

It is noted that any one of the above-described filtering devices 20 is not limited to being used alone. Here, FIG. 11 is a schematic view illustrating an example of a filtration system having a filtering device according to the embodiment of the present invention.

As in a filtration system 30 illustrated in FIG. 11, a configuration in which a plurality of filtering devices 20 are provided, and each of the filtering devices 20 is allowed automatically filter a filtration target may be adopted.

In FIG. 11, the same configuration components as those of the filtering device 20 illustrated in FIG. 7 are designated by the same references, and the detailed description thereof will be omitted.

The filtration system 30 illustrated in FIG. 11 includes a supply unit 32, a plurality of filtering devices 20 that are connected to the supply unit 32 by a pipe 34, and a control unit 36 that controls the supply unit 32.

The supply unit 32 supplies a filtration target to each of the filtering devices 20 and has a storage unit (not illustrated in the figure) for storing a filtration target and a pump (not illustrated in the figure) for supplying the filtration target from the storage unit to the filtering device 20. As the pump, for example, a syringe pump is used. The pump such as a syringe pump is controlled by a control unit 36, and the filtration target is supplied from the storage unit to the filtering device 20 by the pump, filtered, and collected at the collection unit 26.

In the filtration system 30, the filtering device 20 may also have a pressurizing part 28 as illustrated in FIG. 8. In this case, a driving unit (not illustrated in the figure) for moving the plunger 28b of the pressurizing part 28 is provided. In a case where the driving unit and the pump are controlled by the control unit 36, filtration can be automatically executed as described above.

Since the liquid filter 10 has a small pressure loss, the pressure required for filtration can be reduced and the time required for filtration can be shortened in the filtration system 30. As a result, the power consumption of the filtration system 30 can be reduced.

In the filtration system 30, instead of the filtration target, a filtering elimination target can also be supplied and subjected to filtering elimination.

The present invention is basically configured as described above. As described above, the liquid filter, and the manufacturing method for a liquid filter, according to the embodiment of the present invention, have been described in detail; however, the present invention is not limited to the above-described embodiments, and, of course, various improvements or modifications may be made without departing from the gist of the present invention.

### EXAMPLES

Hereinafter, the characteristics of the present invention will be described more specifically with reference to Examples. The materials, reagents, amounts of substances and their ratios, operations, and the like in the following Examples can be appropriately changed as long as they do not depart from the gist of the present invention. Accordingly, the scope of the present invention is not limited to the following Examples.

In present examples, liquid filters of Examples 1 to 13 and Comparative Examples 1 to 5 were prepared. Using each of the liquid filters, the particle filtration test described below was carried out to evaluate the initial filtration pressure and the end point filtration pressure.

[Evaluation]

The particle filtration test is a test in which filtration is carried out using a particle-dispersed aqueous solution containing acrylic monodisperse particles, and the basic physical properties of the liquid filter are evaluated.

In the particle filtration test, the liquid filter was cut out to a diameter of 25 mm and set in a filter holder (SWINNEX, manufactured by Merck Millipore) together with an O-ring.

As the particle-dispersed aqueous solution, each of 0.1% by mass monodisperse particles having a particle size of 1 μm, 3 μm, 5 μm, 8 μm, 10 μm, and 15 μm, respectively, were added to 500 milliliters (mL) of water, whereby 500 mL of the particle-dispersed aqueous solution was prepared.

As the monodisperse particle, the following acrylic monodisperse particles manufactured by Soken Chemical & Engineering Co., Ltd., were used: MX-80H3wT (product number, particle size: 1 μm), MX-300 (product number, particle size: 3 μm), MX-500 (product number, particle size: 5 μm), MX-800 (product number, particle size: 8 μm), MX-1000 (product number, particle size: 10 μm), and MX-1500H (product number, particle size: 15 μm).

The low fiber density side of the liquid filter was arranged on the primary side, that is, on the side from which the particle-dispersed aqueous solution were supplied, and 500 mL of the particle-dispersed aqueous solution was allowed to flow in the direction perpendicular to the surface of the liquid filter and filtered.

The pressure loss during the filtration was measured in real time, the average pressure loss when the processing amount of the particle-dispersed aqueous solution reached 0 to 100 mL was denoted by the initial filtration pressure, and the average pressure loss when the processing amount of the particle-dispersed aqueous solution reached 400 to 500 mL was denoted by the end point filtration pressure. The initial filtration pressure is an average pressure loss in a case where the processing amount is 0% to 20% by volume of the total amount of liquid to be filtered. The end point filtration pressure is an average pressure loss in a case where the processing amount is 80% to 100% by volume of the total amount of liquid to be filtered.

The pressure loss during the filtration was measured in real time as follows.

Pressure gauges were installed on the upstream side and the downstream side of the liquid filter to measure the pressure, and the output of the pressure gauge was recorded at 1-second intervals using GL840 manufactured by GRAPHTEC Corporation. As the pressure gauge, a small pressure gauge GC31 (trade name) manufactured by NAGANO KEIKI Co., Ltd. was used as the pressure gauge.

In both the evaluation of the initial filtration pressure and the evaluation of the end point filtration pressure, an average pressure loss of less than 10 kPa was denoted by A, an average pressure loss of 10 kPa or more and less than 20 kPa was denoted by B, and an average pressure loss of 20 kPa or more was designated by C.

[Liquid Filter]

(Average Through-Hole Diameter)

The average through-hole diameter was measured with a palm porometer by using a bubble point method (Japanese Industrial Standards (JIS) K3832, ASTM F316-86)/Half-dry Method (ASTM E1294-89).

(Void Ratio)

Regarding the void ratio, as described above, in a case where the void ratio was denoted by Pr (%), the film thickness of a nonwoven fabric of a square of 10 cm×10 cm was denoted by Hd (μm), and the mass of a nonwoven fabric of a square of 10 cm×10 cm was denoted by Wd (g), the void ratio was calculated using Pr=(Hd−Wd×67.14)×100/Hd.

(Critical Wet Surface Tension (CWST))

The critical wet surface tension (CWST), which represents wettability, was controlled by the amount of the hydrophilizing agent or the alkali treatment. The method for measuring the critical wet surface tension (CWST) is described below.

Solutions having different surface tensions are prepared. 10 drops of 10 μl, of the solution are gently placed on a horizontally leveled liquid filter and left for 10 minutes. In a case where 9 or more drops out of 10 are wet, it is determined that the liquid filter is wetted by the solution of its surface tension. In a case of being wetted, a solution having a surface tension higher than that of the wetted solution used and is dropped in the same manner, and the procedure is repeated until 2 or more drops out of the 10 drops are no longer wetted. In a case where 2 or more drops out of the 10 drops are not wetted, it is determined that the liquid filter is not wetted by the solution of its surface tension, and the average value of the surface tensions of the wetted solution and the non-wetted solution is defined as the critical wet surface tension (CWST) of the liquid filter.

The difference in the surface tension between the wetted solution and the non-wetted solution is set to be within 2 mN/m, and the measurement is carried out in a standard laboratory atmosphere (Japanese Industrial Standards (JIS) K7100) at a temperature of 23° C. and a relative humidity of 50%. For measurements at different temperatures or humidity, in a case where there exists a conversion table, the table is used to calculate the wetting tension. The criterion for determining that the dropped solution is wet is that the contact angle between the liquid filter and the solution is 90° or less.

Acetic acid aqueous solutions (54 to 70 mN/m) and sodium hydroxide aqueous solutions (72 to 100 mN/m) were used for the critical wet surface tension (CWST) measurement, and the surface tension of the prepared solution was measured with an automatic surface tension meter (manufactured by Kyowa Interface Science Co., Ltd., Wilhelmy plate method) under the same conditions as the environment in which the critical wet surface tension (CWST) was measured.

(Film Thickness)

For the film thickness, a cross-sectional observation of the nonwoven fabric is carried out using a scanning electron microscope to obtain a cross-sectional image. Using the cross-sectional image, 10 points as the film thickness of the nonwoven fabric were measured, and the average value thereof was taken as the film thickness.

(Fiber Density Difference)

For the fiber density difference, an X-ray computed tomography (CT) image in the film thickness direction of the liquid filter is acquired, and the entire film thickness in the cross-sectional X-ray CT image is equally divided into 10 sections in the film thickness direction. The brightness in each of the sections which are obtained by being equally divided into 10 sections was integrated. The integrated brightnesses were denoted by L1, L2, L3, L4, L5, L6, L7, L8, L9, and L10 in order from the lowest brightness, a value of L1/L10 was determined, and this value was used as the fiber density difference. In Examples 1 to 13 and Comparative Examples 1 to 5, among the front surface and the back surface of the nonwoven fabric, the fiber density of any one surface is maximal, and the fiber density of the remaining surface is minimal, and thus the brightness L1 and the brightness L10 are each the brightness of the front surface or the brightness of the back surface.

Further, it was checked whether or not 0.9≤Ln/Ln+1<1.05 was satisfied for the above-described brightnesses L1 to L10. In a case where 0.9≤Ln/Ln+1<1.05 was satisfied, it was described as “Continuous” in the fiber density gradient column, and in a case where the above was not satisfied, it was described as “Discontinuous” in the fiber density gradient column. In Examples 1 to 13, the fiber density continuously changes in the film thickness direction.

In Table 1 and Table 2 below, the materials described in the alphabetical notation are materials shown below.

CAP: Cellulose acetate propionate

CMC: Carboxymethyl cellulose

PET: Polyethylene terephthalate

PP: Polypropylene

PSU: Polysulfone

PVP: Polyvinylpyrrolidone

The average through-hole diameter, the void ratio, the critical wet surface tension (CWST), the film thickness, the fiber density difference, the fiber density gradient, the material, and the manufacturing method of Examples 1 to 13 and Comparative Examples 1 to 5 are shown in Table 1 and Table 2 below.

Hereinafter, Examples 1 to 13 and Comparative Examples 1 to 5 will be described.

### Example 1

In Example 1, a nonwoven fabric was manufactured by an electrospinning method using cellulose acetate propionate (CAP) as a water-insoluble polymer and polyvinylpyrrolidone (PVP) as a hydrophilizing agent, and used as a liquid filter. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

For the nonwoven fabric using the electrospinning method, the nanofiber manufacturing device disclosed in JP6132820A was used, the temperature of the spinning solution coming out of the nozzle was set to 20° C., the flow rate of the spinning solution coming out of the nozzle was set to 20 mL/hour, and the voltage applied between the solution and the collector was adjusted in a range of 10 to 40 kV, and the nanofibers were collected on a support made of an aluminum sheet having a thickness of 25 μm, which was arranged on the collector, whereby a nonwoven fabric was obtained.

The above-described water-insoluble polymer and hydrophilizing agent were dissolved in a mixed solvent of 80% by mass of dichloromethane and 20% by mass of methanol so that the total solid content concentration was 10% by mass, and used as a spinning solution. The ratios of the water-insoluble polymer and the hydrophilizing agent described in Example 1, Examples 2 to 11, and Comparative Examples 1 to 5 shown below is the details of the above-described solid content. This is the same as the ratio of the water-insoluble polymer and the hydrophilizing agent to the total mass of the fibers of the nonwoven fabric.

The fact that cellulose acetate propionate (CAP) is 90% by mass of the total solid content in the mixed solvent is indicated as “CAP/90%” in the “Material” column of Table 1. The fact that polyvinylpyrrolidone (PVP) is 10% by mass of the total solid content in the mixed solvent is indicated as “PVP/10%” in the “Hydrophilizing agent” column of Table 1.

In the following description, in Example 1, it is simply referred to that cellulose acetate propionate (CAP) is 90% by mass and polyvinylpyrrolidone (PVP) is 10% by mass. Hereinafter, substances other than the above will be indicated in the same manner as in Example 1.

In Example 1, the average through-hole diameter is 5.0 μm, the void ratio is 97%, the critical wet surface tension is 85 mN/m, the film thickness is 800 μm, and the fiber density difference is 0.70, and the fiber density gradient is continuous.

### Example 2

In Example 2, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 2, a nonwoven fabric was manufactured by an electrospinning method in the same manner as in Example 1 except that the average through-hole diameter, the film thickness, and the fiber density difference were changed as shown in Table 1 described later, and used as the liquid filter. Cellulose acetate propionate (CAP) is 90% by mass, and polyvinylpyrrolidone (PVP) is 10% by mass. In Example 2, the average through-hole diameter is 4.9 μm, the film thickness is 4,000 μm, and the fiber density difference is 0.76 as compared with Example 1.

### Example 3

In Example 3, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 3, a nonwoven fabric was manufactured by an electrospinning method in the same manner as in Example 1 except that the average through-hole diameter and the fiber density difference were changed as shown in Table 1 described later, and used as the liquid filter. Cellulose acetate propionate (CAP) is 90% by mass, and polyvinylpyrrolidone (PVP) is 10% by mass. In Example 3, the average through-hole diameter is 4.2 μm, and the fiber density difference is 0.94 as compared with Example 1.

### Example 4

In Example 4, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 4, a nonwoven fabric was manufactured by an electrospinning method in the same manner as in Example 1 except that the average through-hole diameter and the critical wet surface tension were changed as shown in Table 1 described later, and used as the liquid filter. Cellulose acetate propionate (CAP) is 97.5% by mass, and polyvinylpyrrolidone (PVP) is 2.5% by mass. In Example 4, the amount of polyvinylpyrrolidone (PVP) is reduced to reduce the critical wet surface tension, the critical wet surface tension is 40 mN/m, the average through-hole diameter is 3.9 μm as compared with Example 1.

### Example 5

In Example 5, polysulfone (PSU) was used as a water-insoluble polymer, and polyvinylpyrrolidone (PVP) was used as a hydrophilizing agent. For polysulfone (PSU), Udel (registered trade mark) P-3500 LCD MB manufactured by Solvay S.A. was used, and for polyvinylpyrrolidone (PVP), K-90 manufactured by Nippon Shokubai Co., Ltd. was used.

In Example 5, a nonwoven fabric was manufactured by an electrospinning method in the same manner as in Example 1 except that the average through-hole diameter, the void ratio, the critical wet surface tension, and the fiber density difference were changed as shown in Table 1 described later, and used as the liquid filter. Polysulfone (PSU) is 90% by mass, and polyvinylpyrrolidone (PVP) is 10% by mass. The water-insoluble polymer of Example 5 is different from that of Example 1. In Example 5, the critical wet surface tension was reduced by the combination of the water-insoluble polymer and the hydrophilizing agent, and the critical wet surface tension was 72 mN/m. In addition, in Example 5, the average through-hole diameter is 3.5 μm, the void ratio is 90%, the critical wet surface tension is 72 mN/m, and the fiber density difference is 0.85 as compared with Example 1.

### Example 6

In Example 6, cellulose acetate propionate (CAP) was used as a water-insoluble polymer, and carboxymethyl cellulose (CMC) was used as a hydrophilizing agent. For cellulose acetate propionate (CAP), CAP-482-20 (trade name) manufactured by Eastman Chemical Company, Japan was used, and for carboxymethyl cellulose (CMC), product number 035-01337 manufactured by FUJIFILM Wako Pure Chemical Corporation was used.

In Example 6, a nonwoven fabric was manufactured by an electrospinning method in the same manner as in Example 1 except that the average through-hole diameter, the void ratio, and the fiber density difference were changed as shown in Table 1 described later, and used as the liquid filter. Cellulose acetate propionate (CAP) is 90% by mass, and carboxymethyl cellulose (CMC) is 10% by mass. In Example 6, the average through-hole diameter is 3.3 μm, the void ratio is 94%, and the fiber density difference is 0.92 as compared with Example 1.

### Example 7

In Example 7, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 7, a nonwoven fabric was manufactured by an electrospinning method in the same manner as in Example 1 except that the average through-hole diameter, the void ratio, and the fiber density difference were changed as shown in Table 1 described later, and used as the liquid filter. Cellulose acetate propionate (CAP) is 45% by mass, and polyvinylpyrrolidone (PVP) is 55% by mass. In Example 7, the average through-hole diameter is 3.6 μm, the void ratio is 95%, and the fiber density difference is 0.94 as compared with Example 1.

### Example 8

In Example 8, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 8, a nonwoven fabric was manufactured by an electrospinning method in the same manner as in Example 1 except that the average through-hole diameter, the film thickness, and the fiber density difference were changed as shown in Table 1 described later, and used as the liquid filter. Cellulose acetate propionate (CAP) is 90% by mass, and polyvinylpyrrolidone (PVP) is 10% by mass. In Example 8, the average through-hole diameter is 4.9 μm, the film thickness is 90 μm, and the fiber density difference is 0.94 as compared with Example 1.

### Example 9

In Example 9, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 9, a nonwoven fabric was manufactured by an electrospinning method in the same manner as in Example 1 except that the average through-hole diameter and the fiber density difference were changed as shown in Table 1 described later, and used as the liquid filter. Cellulose acetate propionate (CAP) is 90% by mass, and polyvinylpyrrolidone (PVP) is 10% by mass. In Example 9, the average through-hole diameter is 1.8 μm, and the fiber density difference is 0.90 as compared with Example 1.

### Example 10

In Example 10, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 10, a nonwoven fabric was manufactured by an electrospinning method in the same manner as in Example 1 except that the average through-hole diameter and the fiber density difference were changed as shown in Table 2 described later, and used as the liquid filter. Cellulose acetate propionate (CAP) is 90% by mass, and polyvinylpyrrolidone (PVP) is 10% by mass. In Example 10, the average through-hole diameter is 12.5 μm, and the fiber density difference is 0.90 as compared with Example 1.

### Example 11

In Example 11, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 11, a nonwoven fabric was manufactured by an electrospinning method in the same manner as in Example 1 except that the average through-hole diameter, the void ratio, and the fiber density difference were changed as shown in Table 2 described later, and used as the liquid filter. Cellulose acetate propionate (CAP) is 90% by mass, and polyvinylpyrrolidone (PVP) is 10% by mass. In Example 11, the average through-hole diameter is 6.2 μm, the void ratio is 72%, and the fiber density difference is 0.92 as compared with Example 1.

### Example 12

In Example 12, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 12, a nonwoven fabric was manufactured by an electrospinning method in the same manner as in Example 1 except that the average through-hole diameter, the film thickness, and the fiber density difference were changed as shown in Table 2 described later, and used as the liquid filter. Cellulose acetate propionate (CAP) is 90% by mass, and polyvinylpyrrolidone (PVP) is 10% by mass. In Example 12, the average through-hole diameter is 4.3 μm, the film thickness is 2,000 μm, and the fiber density difference is 0.72 as compared with Example 1.

### Example 13

In Example 13, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Example 13, a nonwoven fabric was manufactured by an electrospinning method in the same manner as in Example 1 except that the average through-hole diameter, the film thickness, and the fiber density difference were changed as shown in Table 2 described later, and used as the liquid filter. Cellulose acetate propionate (CAP) is 90% by mass, and polyvinylpyrrolidone (PVP) is 10% by mass. In Example 13, the average through-hole diameter is 4.0 μm, the film thickness is 250 μm, and the fiber density difference is 0.80 as compared with Example 1.

### Comparative Example 1

In Comparative Example 1, a nonwoven fabric having a film thickness of 500 μm was manufactured by a spun bonding method using polypropylene (PP). In Comparative Example 1, the average through-hole diameter is 2.9 μm, the void ratio is 80%, the critical wet surface tension is 30 mN/m, the film thickness is 500 μm, the fiber density difference is 0.99, and there is no fiber density gradient. That is, Comparative Example 1 is isotropic without anisotropy of fiber density.

For polypropylene (PP), WINTEC (registered trade mark) WSX02 manufactured by Japan Polypropylene Corporation was used.

### Comparative Example 2

In Comparative Example 2, a nonwoven fabric having a film thickness of 350 μm was manufactured by a melt blow method using polyethylene terephthalate (PET). In Comparative Example 2, the average through-hole diameter is 4.5 μm, the void ratio is 82%, the critical wet surface tension is 65 mN/m, the film thickness is 350 μm, the fiber density difference is 0.99, and there is no fiber density gradient. That is, Comparative Example 2 is isotropic without anisotropy of fiber density.

As the polyethylene terephthalate (PET), SA-1206 manufactured by UNITIKA Ltd. was used.

### Comparative Example 3

In Comparative Example 3, only cellulose acetate propionate (CAP) was used without using a hydrophilizing agent. For cellulose acetate propionate (CAP), CAP-482-20 (trade name) manufactured by Eastman Chemical Company, Japan was used.

In Comparative Example 3, a nonwoven fabric was manufactured by an electrospinning method in the same manner as in Example 1 except that the average through-hole diameter, the void ratio, the critical wet surface tension, the film thickness, and the fiber density difference were changed as shown in Table 2 described later and there was no fiber density gradient, and used as the liquid filter. In Comparative Example 3, the average through-hole diameter is 4.8 μm, the void ratio is 90%, the critical wet surface tension is 40 mN/m, the film thickness is 200 μm, the fiber density difference is 0.99, and there is no fiber density gradient as compared with Example 1. That is, Comparative Example 3 is isotropic without anisotropy of fiber density.

### Comparative Example 4

In Comparative Example 4, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Comparative Example 4, a nonwoven fabric having a film thickness of 400 μm was formed by the electrospinning method in the same manner as in Example 1 except that the fiber density difference was changed as shown in Table 2 described later and the fiber density gradient was made discontinuous, and then the manufacturing was once stopped and the surface of the nonwoven fabric was statically eliminated with a static eliminator (manufactured by MILTY, a static electricity removal pistol Zerostat 3 (trade name)). Subsequently, the surface of the statically eliminated nonwoven fabric was subjected to the spinning again by the electrospinning method under the same conditions so that the total film thickness was 800 μm. In this manner, a nonwoven fabric having a discontinuous fiber density was manufactured and used as the liquid filter. Cellulose acetate propionate (CAP) is 90% by mass, and polyvinylpyrrolidone (PVP) is 10% by mass. In Comparative Example 4, the fiber density difference is 0.88 as compared with Example 1.

### Comparative Example 5

In Comparative Example 5, cellulose acetate propionate (CAP) was used as a water-insoluble polymer, and polyvinylpyrrolidone (PVP) was used as a hydrophilizing agent. For cellulose acetate propionate (CAP), CAP-482-20 (trade name) manufactured by Eastman Chemical Company, Japan was used, and for polyvinylpyrrolidone (PVP), K-90 manufactured by Nippon Shokubai Co., Ltd. was used.

In Comparative Example 5, three nonwoven fabrics were manufactured by an electrospinning method in the same manner as in Example 1 except that the average through-hole diameter, the film thickness, and the fiber density difference were changed as shown in Table 2 described later and the fiber density gradient was made discontinuous, and the three nonwoven fabrics were laminated and used as the liquid filter. Cellulose acetate propionate (CAP) is 90% by mass, and polyvinylpyrrolidone (PVP) is 10% by mass. In Comparative Example 5, the fiber density gradient of one nonwoven fabric is continuous, but the fiber density is discontinuous as a liquid filter. In Comparative Example 5, the average through-hole diameter is 5.2 μm, the film thickness is 250 μm, and the fiber density difference is 0.93 as compared with Example 1.

TABLE 1

| | Example 1 | Example 2 | Example 3 | Example 4 | Example 5 | Example 6 | Example 7 | Example 8 | Example 9 |
|---|---|---|---|---|---|---|---|---|---|
| Average | 5.0 | 4.9 | 4.2 | 3.9 | 3.5 | 3.3 | 3.6 | 4.9 | 1.8 |
| through-hole | | | | | | | | | |
| diameter | | | | | | | | | |
| (μm) | | | | | | | | | |
| Void ratio (%) | 97 | 97 | 97 | 97 | 90 | 64 | 95 | 97 | 97 |
| Wettability | 85 | 85 | 85 | 40 | 72 | 85 | 85 | 85 | 85 |
| (CWST (mN/m)) | | | | | | | | | |
| Film | 800 | 4000 | 800 | 250 | 800 | 800 | 800 | 90 | 800 |
| thickness (μm) | | | | | | | | | |
| Fiber density | 0.70 | 0.76 | 0.94 | 0.70 | 0.85 | 0.92 | 0.94 | 0.94 | 0.90 |
| difference | | | | | | | | | |
| (L1/L10) | | | | | | | | | |
| Fiber density | Continuous | Continuous | Continuous | Continuous | Continuous | Continuous | Continuous | Continuous | Continuous |
| gradient | | | | | | | | | |
| Single layer/ | Single layer | Single layer | Single layer | Single layer | Single layer | Single layer | Single layer | Single layer | Single layer |
| laminate | | | | | | | | | |
| Material | CAP/90% | CAP/90% | CAP/90% | CAP/97.5% | PSU/90% | CAP/90% | CAP/45% | CAP/90% | CAP/90% |
| Hydrophilizing | PVP/10% | PVP/10% | PVP/10% | PVP/2.5% | PVP/10% | CMC/10% | PVP/55% | PVP/10% | PVP/10% |
| agent | | | | | | | | | |
| Manufacturing | Electro- | Electro- | Electro- | Electro- | Electro- | Electro- | Electro- | Electro- | Electro- |
| method | spinning | spinning | spinning | spinning | spinning | spinning | spinning | spinning | spinning |
| Initial filtration | A | A | B | B | A | B | B | B | B |
| pressure | | | | | | | | | |
| End point | A | B | B | B | B | B | B | B | B |
| filtration | | | | | | | | | |
| pressure | | | | | | | | | |

TABLE 2

| | Example | Example | Example | Example | Comparative | Comparative | Comparative | Comparative | Comparative |
|---|---|---|---|---|---|---|---|---|---|
| | 10 | 11 | 12 | 13 | Example 1 | Example 2 | Example 3 | Example 4 | Example 5 |
| Average | 12.5 | 6.2 | 4.3 | 4.0 | 2.9 | 4.5 | 4.8 | 5.0 | 5.2 |
| through-hole | | | | | | | | | |
| diameter | | | | | | | | | |
| (μm) | | | | | | | | | |
| Void ratio (%) | 85 | 72 | 97 | 97 | 80 | 82 | 90 | 97 | 97 |
| Wettability | 85 | 85 | 85 | 85 | 30 | 65 | 40 | 85 | 85 |
| (CWST (mN/m)) | | | | | | | | | |
| Film | 800 | 800 | 2000 | 250 | 500 | 350 | 200 | 800 | 250 |
| thickness (μm) | | | | | | | | | |
| Fiber density | 0.95 | 0.92 | 0.72 | 0.80 | 0.99 | 0.99 | 0.99 | 0.88 | 0.93 |
| difference | | | | | | | | | |
| (L1/L10) | | | | | | | | | |
| Fiber density | Con- | Con- | Con- | Con- | Absent | Absent | Absent | Dis- | Dis- |
| gradient | tinuous | tinuous | tinuous | tinuous | | | | continuous | continuous |
| Single layer/ | Single | Single | Single | Single | Single | Single | Single | Single | Three-layer |
| laminate | layer | layer | layer | layer | layer | layer | layer | layer | laminate |
| Material | CAP/90% | CAP/90% | CAP/90% | CAP/90% | PP | PET | CAP | CAP/90% | CAP/90% |
| Hydrophilizing | PVP/10% | PVP/10% | PVP/10% | PVP/10% | — | — | — | PVP/10% | PVP/10% |
| agent | | | | | | | | | |
| Manufacturing | Electro- | Electro- | Electro- | Electro- | Spun | Melt blow | Electro- | Electro- | Electro- |
| method | spinning | spinning | spinning | spinning | bonding | | spinning | spinning | spinning |
| Initial filtration | B | B | A | A | C | C | C | B | B |
| pressure | | | | | | | | | |
| End point | B | B | A | A | C | C | C | C | C |
| filtration | | | | | | | | | |
| pressure | | | | | | | | | |

As shown in Table 1 and Table 2, Examples 1 to 13 were excellent in the initial filtration pressure and the end point filtration pressure and were liquid filters having a small pressure loss as compared with Comparative Examples 1 to 5.

In Comparative Example 1, the composition and the manufacturing method for a liquid filter are different, there is no hydrophilizing agent, the critical wet surface tension (CWST) is low, and the fiber density difference is small. In addition, the average through-hole diameter was small, the void ratio was low, the film thickness was thin, and the pressure loss was large.

In Comparative Example 2, the composition and the manufacturing method for a liquid filter are different, there is no hydrophilizing agent, the critical wet surface tension (CWST) is low, and the fiber density difference is small. In addition, the average through-hole diameter was small, the void ratio was low, the film thickness was thin, and the pressure loss was large.

In Comparative Example 3, there is no hydrophilizing agent, the critical wet surface tension (CWST) is low, and the fiber density difference is small. In addition, the average through-hole diameter was small, the void ratio was low, the film thickness was thin, and the pressure loss was large.

In Comparative Example 4, the fiber density gradient was discontinuous, and the pressure loss was large.

Comparative Example 5 had a configuration of a three-layer laminate, and as the liquid filter, the fiber density gradient was discontinuous, and the pressure loss was large.

From Example 1, Example 2, Example 8, Example 12, and Example 13, it can be seen that in a case where the film thickness is in a range of 200 μm to 2,000 μm, the initial filtration pressure and the end point filtration pressure are more excellent, which is preferable.

From Example 1 and Example 3, it can be seen that in a case where the fiber density difference is large, the pressure loss is small, which is preferable.

From Example 1, Example 4, and Example 5, it can be seen that in a case where the critical wet surface tension is high, particularly in a case where the critical wet surface tension is 72 mN/m or more, the pressure loss is small, which is preferable.

From Example 1 and Example 6, it can be seen that the hydrophilizing agent is preferably polyvinylpyrrolidone (PVP) which is more excellent in the initial filtration pressure and the end point filtration pressure. Polyvinylpyrrolidone (PVP) has high compatibility with a water-insoluble polymer and high hydrophilicity as compared with other materials.

From Example 1 and Example 7, it can be seen that in a case where the content of the hydrophilizing agent is 50% by mass or less, the initial filtration pressure and the end point filtration pressure are more excellent, which is preferable. In a case where the content of the hydrophilizing agent is 50% by mass or less, the strength of the fibers forming the nonwoven fabric is suppressed, and the shape hardly changes by filtration.

From Example 1, Example 9, and Example 10, it can be seen that in a case where the average through-hole diameter is 2.0 μm or more and less than 10.0 μm, the initial filtration pressure and the end point filtration pressure are more excellent, which is preferable. In a case where the average through-hole diameter is large, it is necessary to increase the fiber diameter; however, since it takes time for a solvent to be dried during the spinning by the electrospinning method, the fibers of the manufactured nonwoven fabric are welded to each other. As a result, the fiber density difference and the void ratio become smaller, which leads to an increase in filtration pressure.

From Example 1 and Example 11, it can be seen that in a case where the void ratio is 75% or more and 98% or less, the initial filtration pressure and the end point filtration pressure are more excellent, which is preferable.

### EXPLANATION OF REFERENCES

10: liquid filter
12: nonwoven fabric
12a: front surface
12b: back surface
14: porous body
20: filtering device
22: case
22a: inside
22b: bottom part
22c: opening portion
22d: outer surface
24: connecting pipe
26: collection unit
27: supply pipe
28: pressurizing part
28a: gasket
28b: plunger
30: filtration system
32: supply unit
34: pipe
36: control unit
50: pressure curve
52: pressure curve
100: conventional nonwoven fabric
Dt: film thickness direction
h: film thickness

What is claimed is:

1. A liquid filter comprising a nonwoven fabric formed of fibers containing a water-insoluble polymer and a hydrophilizing agent,
wherein in the nonwoven fabric, a fiber density continuously changes in a film thickness direction, a fiber density difference is present in the film thickness direction, the fiber density of one surface of the nonwoven fabric in the film thickness direction is maximal, and the fiber density of the other surface of the nonwoven fabric in the film thickness direction is minimal.

2. The liquid filter according to claim 1,
wherein the hydrophilizing agent is at least one of polyvinylpyrrolidone, polyethylene glycol, carboxymethyl cellulose, or hydroxypropyl cellulose.

3. The liquid filter according to claim 1,
wherein the nonwoven fabric has a film thickness of 200 μm or more and 2,000 μm or less.

4. The liquid filter according to claim 1,
wherein the nonwoven fabric has an average through-hole diameter of 2.0 μm or more and less than 10.0 μm.

5. The liquid filter according to claim 1,
wherein the nonwoven fabric has a void ratio of 75% or more and 98% or less.

6. The liquid filter according to claim 1,
wherein the nonwoven fabric has a critical wet surface tension of 72 mN/m or more.

7. The liquid filter according to claim 1,
wherein the water-insoluble polymer is any one of polyethylene, polypropylene, polyester, polysulfone, polyethersulfone, polycarbonate, polystyrene, a cellulose derivative, an ethylene vinyl alcohol polymer, polyvinyl chloride, polylactic acid, polyurethane, polyphenylene sulfide, polyamide, polyimide, polyvinylidene fluoride, polytetrafluoroethylene, or an acrylic resin, or a mixture thereof.

8. The liquid filter according to claim 1,
wherein the water-insoluble polymer is formed of a cellulose derivative.

9. The liquid filter according to claim 1,
wherein a content of the hydrophilizing agent with respect to a total mass of the fibers of the nonwoven fabric is 1% to 50% by mass.

10. A manufacturing method for the liquid filter according to claim 1,
wherein the liquid filter is manufactured by using an electrospinning method.

11. The liquid filter according to claim 2,
wherein the nonwoven fabric has a film thickness of 200 μm or more and 2,000 μm or less.

12. The liquid filter according to claim 2,
wherein the nonwoven fabric has an average through-hole diameter of 2.0 μm or more and less than 10.0 μm.

13. The liquid filter according to claim 2,
wherein the nonwoven fabric has a void ratio of 75% or more and 98% or less.

14. The liquid filter according to claim 2,
wherein the nonwoven fabric has a critical wet surface tension of 72 mN/m or more.

15. The liquid filter according to claim 2,
wherein the water-insoluble polymer is any one of polyethylene, polypropylene, polyester, polysulfone, polyethersulfone, polycarbonate, polystyrene, a cellulose derivative, an ethylene vinyl alcohol polymer, polyvinyl chloride, polylactic acid, polyurethane, polyphenylene sulfide, polyamide, polyimide, polyvinylidene fluoride, polytetrafluoroethylene, or an acrylic resin, or a mixture thereof.

16. The liquid filter according to claim 2,
wherein the water-insoluble polymer is formed of a cellulose derivative.

17. The liquid filter according to claim 2,
wherein a content of the hydrophilizing agent with respect to a total mass of the fibers of the nonwoven fabric is 1% to 50% by mass.

18. A manufacturing method for the liquid filter according to claim 2,
wherein the liquid filter is manufactured by using an electrospinning method.

19. The liquid filter according to claim 3,
wherein the nonwoven fabric has an average through-hole diameter of 2.0 μm or more and less than 10.0 μm.

20. The liquid filter according to claim 3,
wherein the nonwoven fabric has a void ratio of 75% or more and 98% or less.
